(19) United States
(12) Patent Application Publication
(10) Pub. No.: US 2009/0028142 A1
(43) Pub. Date: Jan. 29, 2009

(54) STREAMING DATA CONTENT IN A NETWORK

(76) Inventors: Brian K. Schmidt, Sunnyvale, CA (US); James G. Hanko, Redwood City, CA (US); J. Duane Northcutt, Menlo Park, CA (US)

Correspondence Address: SILICON IMAGE/BSTZ;BLAKELY SOKOLOFF TAYLOR & ZAFMAN LLP, 1279 OAKMEAD PARKWAY, SUNNYVALE, CA, 94085-4040, US

(21) Appl. No.: 11/828,226

(22) Filed: Jul. 25, 2007

(51) Int. Cl. H04L 12/28; H04L 12/56

(52) U.S. Cl. 370/389

(57) ABSTRACT

A method and apparatus for streaming data content in a network. Some embodiments of an apparatus include a network unit to generate a stream of data on a network, where the generation of the stream of data includes the generation of summary information for the data. The apparatus also includes a transmitter to transmit the generated stream of data via the network.

### TECHNICAL FIELD

Embodiments of the invention generally relate to the field of networks and, more particularly, to a method and apparatus for streaming data content in a network.

### BACKGROUND

As personal electronic entertainment choices increase, there is more incentive to connect the various media devices together in a network in order to share data, increase convenience, and make fuller use of each element. For example, certain devices within a home may be connected together. In such an environment, there are multiple potential sources and users of streaming digital media content for audio, video, gaming, and other uses.

In order to establish an entertainment network, it is possible to use traditional computer networking models to network devices together. In such an environment, streaming media data may potentially be transferred between a server and other networked devices using known data transfer protocols.

However, conventional networking generally requires a high degree of computational power for network devices. Further, the transfer protocols generally require a high level of knowledge regarding the transferred data. Streaming media data currently exists in a wide variety of formats for different purposes and devices. The formats are proliferating as older formats are replaced or supplemented by newer protocols that are intended to provide new functionality or to support new device technologies. As a result, the network of devices may require relatively sophisticated interfacing and computational operation for each device within the entertainment network, and may be vulnerable to the rapid changes in media technology.

### SUMMARY OF THE INVENTION

A method and apparatus are provided for streaming data content in a network.

In a first aspect of the invention, an apparatus may include a network unit to generate a stream of data on a network, where the generation of the stream of data includes the generation of summary information for the data. The apparatus also may include a transmitter to transmit the generated stream of data.

In a second aspect of the invention, an apparatus may include a receiver to receive a stream of data from a second apparatus, where the data is encoded and contains summary information regarding the data. The apparatus also may include a network unit to handle the stream of data based at least in part on the summary information regarding the data.

In a third aspect of the invention, a network may include a first network device to generate a stream of data on the network, where the data is encoded according to a data protocol. Generating the stream of data includes decoding the data at least in part, evaluating the data to obtain summary information regarding the data, and inserting the summary information into the data. The network may further include a second network device to receive the stream of data from the first network device.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is an illustration of embodiments of an entertainment network;

FIG. 2 is an illustration of embodiments of a connection between network devices in a network;

FIG. 3 is an illustration of the preparation of data for transport in a network;

FIG. 4 is an illustration of embodiments of a summary header for data;

FIG. 5 is an illustration of embodiments of headers provided for data;

FIG. 6 is an illustration of embodiments of a process for transport of streaming data in a network;

FIG. 7 is an illustration of embodiments of a process for summarization of streaming data; and

FIG. 8 is an illustration of embodiments of a network device.

### DETAILED DESCRIPTION

Embodiments of the invention are generally directed to streaming media content.

As used herein, “entertainment network” means an interconnection network to deliver digital media content (including music, audio/video, gaming, photos, and others) between devices. An entertainment network may include a personal entertainment network, such as a network in a household, an entertainment network in a business setting, or any other network of entertainment devices. In such a network, certain network devices may be the source of media content, such as a digital television tuner, cable set-top box, video storage server, and other source device. Other devices may display or use media content, such as a digital television, home theater system, audio system, gaming system, and other devices. Further, certain devices may be intended to store or transfer media content, such as video and audio storage servers. Certain devices may perform multiple media functions. In some embodiments, the network devices may be co-located on a single local area network. In other embodiments, the network devices may span multiple network segments, such as through tunneling between local area networks. The entertainment network may include multiple data encoding and encryption processes.

In some embodiments, a network encapsulates a data stream to allow the transfer, storage, and manipulation of the data without decrypting or decoding the data. In some embodiments, a network utilizes a digital packet container format for data that summarizes the data content for network operation without requiring any knowledge of the actual content, coding, or encryption. As used herein, summarizing includes summarizing, characterizing, and identifying data.

Because a wide variety of different devices may be present on an entertainment network, a wide variety of media formats may be in use. However, in order for all devices to carry or store the digital media content in a conventional operation, every device would be required to understand all possible formats, or a data container format is required to allow opaque transmission and storage of arbitrarily formatted content. In some embodiments, a network allows transfer of data without requiring knowledge of all formats, and without utilizing a completely opaque container format. In addition, transferred media content may be encrypted. In some embodiments, a container format is implemented to include information that enables the manipulation of data content without requiring decryption of the data by all devices handling such data.

In some embodiments, an existing networking protocol may be utilized for the transfer of digital data. A variety of networking protocols exist that would be suitable for carrying payloads comprised of digital media. In one example, RTP (Real-time Transfer Protocol) may be utilized to transfer audio, video, and other media data. RTP includes encapsulations for a wide variety of media formats, and can be carried directly via UDP (User Datagram Protocol) or can be encapsulated within TCP (Transmission Control Protocol), if extra user-level packetization is employed in TCP.

However, utilizing RTP directly for transport may require that some devices understand all format types, which is difficult or impractical in a network such as an entertainment network. In an example, if it is desired that a video storage server provide for “trick-play” support (including, for example, fast forward, rewind, and similar operations), this would require knowledge of the data format in a conventional system. In this example, when the video storage server receives an RTP-encapsulated stream to be stored, the server may wish to create an index to relate stream presentation time to stream data position. In order to create this time-based index, the storage server generally would be required to decode, at least in part, all media formats in order to determine the index points. With a large number of possible formats in use in a network, this operation is impractical in operation. Further, in order to decode encrypted media content, the video storage server would require cryptographic support and the necessary keys to access all data. This is difficult because the storage server normally would not be a trusted device.

In some embodiments, a summarization format is implemented in media data. In some embodiments, any networking entity that supports the network format may utilize the summarization format in order to serve as a common carrier of data without requiring knowledge by the networking entity of the content format, data encoding, or data encryption. In some embodiments, the data summarization is implemented via an extension to an existing protocol, including, but not limited to, the widely used RTP. In some embodiments, the data summarization may allow the simplification of the design of common carrier network devices, such as storage devices, that do not need to interpret the media content, and may enable modular designs of streaming engines for network devices because a single protocol and packet format may potentially be used for all types of data. Certain meta-data relating to a stream may be required in order to address the data. In some embodiments, only data source devices need to be burdened with the requirement to extract the required information from the data.

In some embodiments, a common carrier device may operate to receive a data stream with the summary information; recreate the timing of the data stream for re-transmission of the data stream; inflate any compressed null data packets for retransmission; provide for trick-play operations in transmission, including fast forward, rewind, jumping in the data stream, faster and slower transmission in forward and reverse, and splicing data; and retransmit the data stream without decrypting the data.

In a network communication, a generator of digital media (which may be, for example, a digital television tuner or a digital camera) and a user or recipient of the data (which may be, for example, a digital television) conventionally are required to understand and agree upon the media encoding and have the rights to encrypt or decrypt the content. In some embodiments, the data generator may decrypt and partially decode the data content to obtain certain summary information about the content. In some embodiments, the generator encapsulates the media content, which may be encoded and encrypted in a media summarization format to reflect the characteristics of the data. In some embodiments, the recipient device may receive and transfer the media data using the media summarization without agreement to or knowledge of the media encoding and without rights to decrypt or encrypt the data.

In some embodiments, the summary format provided in a summary header will be inclusive of any media encodings that are packaged as data streams. Any data that is transferred may be reflected in such coding. For example, photo data may be interpreted as a video stream with a single frame, and thus be transferred as video stream data. In some embodiments, the summary header provides an approach that may enable low-cost, low-resource implementations of network devices, such as in single chip solutions for network device interfaces. In contrast, conventional home network schemes are designed for high-resource environments, such as those including a personal computer or including multiple custom ASICs or co-processors in network devices.

In some embodiments, a summary header may be implemented as an extension of a header that is provided by the transport protocol. For example, the summary header may be implemented as an RTP header extension.

In some embodiments, digital media may be carried via unreliable datagram protocols, such as UDP/IP (where the reliability of a protocol regards whether the protocol has provisions for verifying whether data has arrived or is intact). Because media data must be delivered under certain time constraints, the need for reliable transmission is time-dependent and content-specific. For this reason, the media data may be effectively transported over an unreliable protocol. These protocols may typically operate over local area networks. Through the use of bridging, a protocol may be made to span multiple local area networks. Because media data streams generally include a time-critical component, guaranteed delivery of data is not necessary (because old data is not useful). Further, guaranteed data delivery could degrade the overall quality of service when there is congestion in the network by delaying packets beyond acceptable limits.

In some embodiments, a summary header provides a variety of information related to the data content. This information forms a set of data-independent annotations that provide certain details about the stream to enable network devices to manage or manipulate the stream without understanding the stream contents. Several of the annotations included in the header represent static information that is inherent to the content itself, such as the content type flags and the stream-relative timestamp.

Acquiring the information for the summary necessitates a certain amount of parsing and understanding of the stream contents. In one example, in order to extract a stream-relative timestamp for a particular section of an MPEG stream, a device would provide partial decoding of the MPEG data to determine the presentation time stamps. In some embodiments, this function is limited to network ingress devices, which is a device that admits content onto the network, such as a broadcast tuner or Internet gateway. The ingress device would also manage any external content protection scheme. In some embodiments, other devices within the network, such as storage devices, may then manipulate the stream without being required to support partial or complete decoding of a plethora of content types, and without being required to decrypt protected content. In some embodiments, an ingress device receives content protected data with an external conditional access scheme, decrypts the content, parses and annotates the content to provide summary information, encrypts the payload content according to the network protection scheme, and disseminates the data within the network.

In some embodiments, summary information is preserved whenever data contents are buffered, such as on a storage device. The annotations providing the summary information enable the successful re-transmission of the stream according to the original time base, as well as allowing jumping to time-referenced points in the stream or utilizing trick play modes.

In some embodiments, content type and mode flags in a summary header may be used by the physical network layer to assign packet priorities for transmission. The priorities established may vary according to the particular implementation In one possible example, the following relative priority order may be used (from highest to lowest priority): (a) embedded content protection keys, (b) audio data, (c) primary key video frame data, (d) secondary key video frame data, (e) non-key video frame data, (f) null data, and (g) bandwidth reservation data.

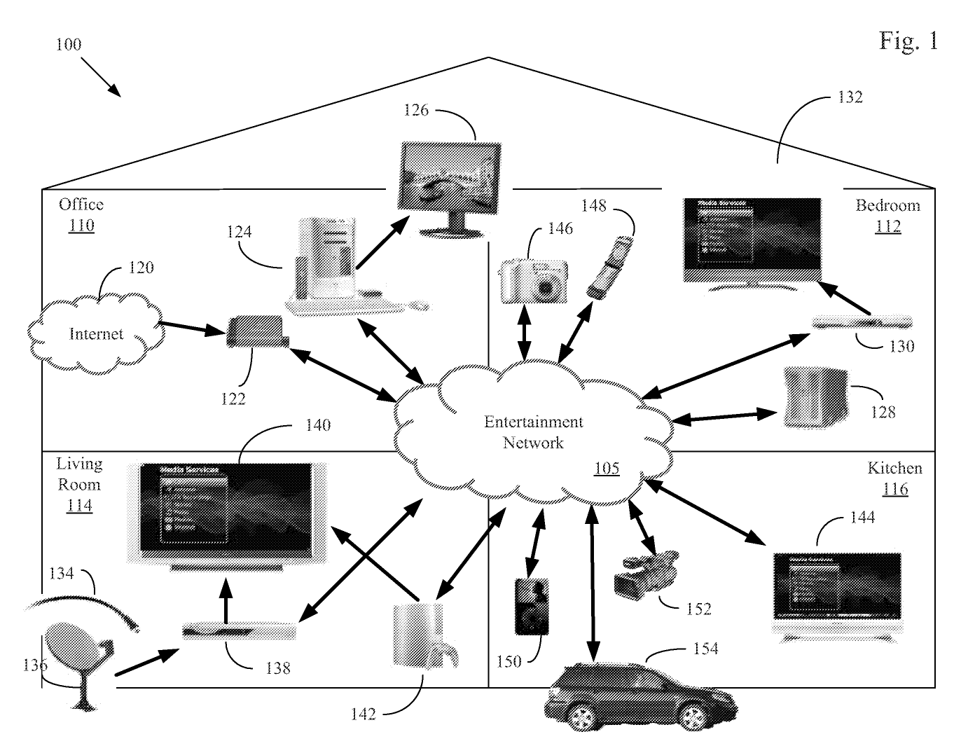

FIG. 1 is an illustration of embodiments of an entertainment network. In this illustration, the entertainment network system 100 provides for the connection of any compatible media device to the network. The connection is shown as a connection to entertainment network 105. In some embodiments, the devices operate as network without a central network server. Through the entertainment network, media data streams may be transferred between any of the connected devices. In addition, devices may be controlled remotely through the network. The devices may be connected to the network via any known connector and connection protocol, including coaxial cables, Ethernet cables, and Firewire, and wireless connections via Wi-Fi, Bluetooth, and other wireless technologies.

In some embodiments, the devices may include any media sources or recipients. In FIG. 1, an office 110 may provide an Internet connection 120 via a gateway 122 to the network 105. The data received from the Internet may include any streaming media sources, including, but not limited to, purchased audio files (such as downloaded music files), video files (such as movies, television, and other), and computer games. The office 110 may also be connected to a personal computer 124 that utilizes a monitor 126, which may, among other functions, display certain media streams or operate certain computer games.

The entertainment network may also be connected with devices in a bedroom 112, which may, for example, contain a set top box 130 to provide data to a television 132. In addition, the bedroom (or any other space) may contain a media storage unit 128. The media storage unit 128 may receive data from any source connected to the network 105, and may provide to any data recipient connected to the network 105. The media storage unit 128 may contain any type of media stream data for the network.

The system may further include a living room 114 receiving, for example, input from a cable or fiber system 134 or from a satellite dish network 136. The media input from such sources may be provided to a set top box 138 connected to the network 105 and to a second television 140. Also connected to the network 105 for display on the living room television 140 may be a video game unit 142. There may be any number of other rooms with networked devices, such as a kitchen containing a third television 144 connected to the network 105. Other network devices may also be present, including, but not limited to, a stereo audio system that may include speakers placed throughout the house.

In addition, any number of mobile personal electronic devices may connect to the network. The devices may connect via a cable or via a wireless signal, including, but not limited to, Bluetooth, Wi-Fi, infrared or other similar wireless communication protocol. Each such protocol may require an interface to the network (which are not shown in FIG. 1), such as a Wi-Fi base station. Such mobile personal electronic devices could include a digital camera 146, a cellular telephone 148, a personal music device 150, or a video camera 152. In addition, a mobile system contained in an automobile 154 may connect to the network 105 when the automobile is in close proximity to the network (such as when present in a garage of the house). The mobile personal electronic devices may, for example, automatically connect to the network when within range of the network. While connected, the devices may be available to obtain data through the network or to provide data to the network, including possible automatic updates or downloads to the devices. In one example, a user may be able to access the data contained in any of the mobile electronic devices through the network, such as accessing the photographs stored on the digital camera 146 on the living room television 140 via the set top box 138.

Because the devices connected to the network vary in function, the data transferred through the network will include many different data protocols, including any known video and audio protocols. In one example, the media storage unit 128 may be required to obtain, store, and provide data of multiple different media protocols.

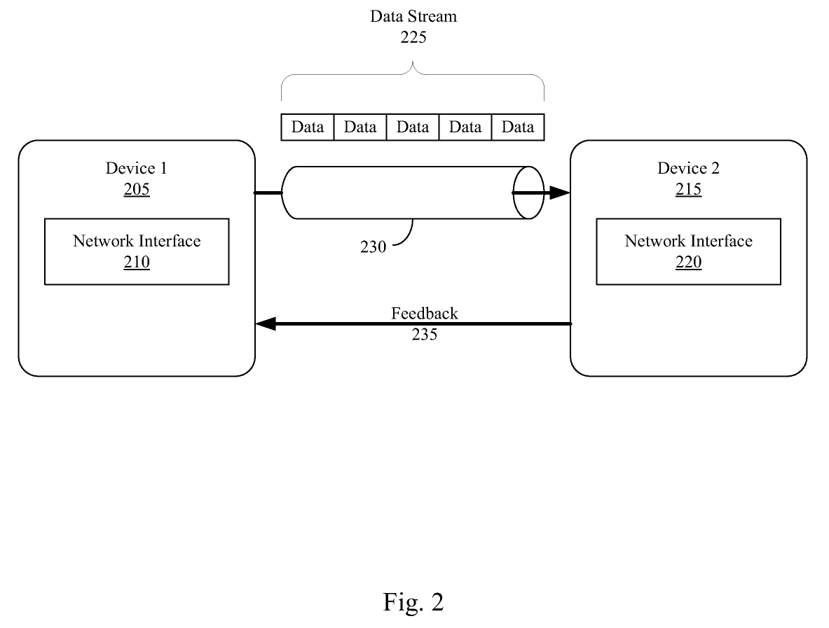

FIG. 2 is an illustration of embodiments of a connection between network devices in a network. In this illustration, a first network device 205 (Device 1) is connected to a second network device 215 (Device 2) via a network, which may include an entertainment network. (The remainder of the network is not shown in FIG. 2, but may include, for example, devices such as those shown in FIG. 1.) Each network device may include a network interface (network interface 210 for the first device 205 and network interface 220 for the second device 215) to enable the device to operate in the network.

In this illustration, first device 205 may be a source of a data stream 225 and second device 215 may be the recipient of the data stream. For example, a request may be made to first device 205 to provide the data stream 225 to second device 215. However, the network devices may be any type of media device, and thus the data stream 225 may be coded according to one of many data protocols, and may be encrypted by an encryption method. The second device 215 may not have the ability to decode or decrypt the data stream 225, and may not have authority to access the data contained in the data stream.

In some embodiments, the data stream is encapsulated by a data summarization format 230 that enables second device 215 to carry the data of the data stream 225 without knowledge of the content format, encoding, or encryption. In some embodiments, the data summarization format may be implemented in the form of a summary header that provides information needed to carry and manipulate the data within the stream without accessing such data.

In some embodiments, second device 215 may be configured to provide low level feedback 235 to first device 205 regarding the media data arrival. For example, second device 215 may provide a negative acknowledgement (NAK signal) if data does not arrive or arrives out of order, allowing first device 205 to, for example, re-send the missing data elements.

In another example, second device 215 may provide a positive acknowledgement (ACK signal) to first device 205 when data arrives.

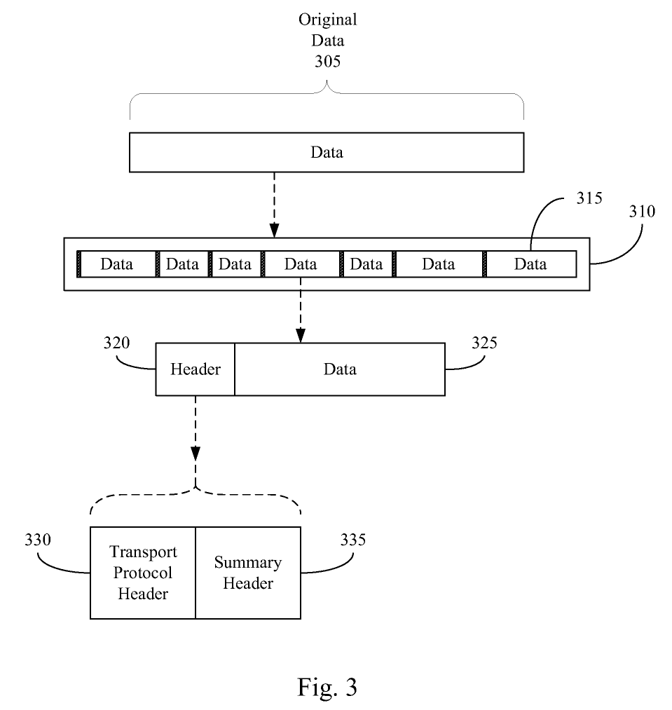

FIG. 3 is an illustration of the preparation of data for transport in a network. For example, data that requires transfer may begin in a first form 305. The data may be broken into data chunks 315 for transfer in a data packet, according to the transport protocol used for delivery of the data in the network.

In some embodiments, the preparation of data may further include the encapsulation of the data via a data summarization format. In some embodiments, the encapsulation utilizes a data packet header 320 with the data of a data chunk 325. The header allows device 2 215 to operate as a common carrier to carry the data in the data stream without knowledge of the content format, encoding, or encryption.

In some embodiments, the header 320 for the data chunk may include two portions:

(a) A transport protocol header 330 (such as an RTP header) including the information required for the transport protocol.

(b) A summary header 335 added to provide information regarding the data 225, without providing any information regarding the data content. In some embodiments, a network device may utilize the summary header to carry and manipulate the data 325 without decoding or decrypting the data. The summary header may be a portion of or extension of the transport protocol header.

In order to transfer digital content in a network, the content is generally decomposed into data “chunks” that are suitable for network delivery according to the relevant transport protocol. For example, if a particular data encoding format is MPEG Transport Stream and the transport protocol is UDP/IP, then an underlying Ethernet frame would allow up to seven 188-byte transport stream cells to be encapsulated within the UDP payload. In this particular example, variable-sized chunks would be permitted. In some embodiments, for each such data chunk, the following fields may be included in a summary header to describe the contents of the chunk:

(a) Size of the data chunk—A field may be provided to reflect size. However, the size may be implied by the packet length and thus not be required in the summary header.

(b) Mode and Content Flags—A mode flags field may provide certain mode information, including, but not limited to, existence of encryption, bandwidth reservation, data congestion, trick play mode, splice mode, and specific data operations. In one possible example, mode indicators may indicate modes for normal operation (no trick play), trick play with full data (no splice mode for data—enabling transmission of the stream at a faster or slower rate), and trick play with partial data (splice mode enabled—enabling skipping around in the stream, which would not be practical if all data is utilized). In some embodiments, a receiving device may automatically adjust decode operations based on the trick play mode. A content flags field may be used to indicate the type of data carried in the chunk. This may include, but is not limited to, indicators for audio data, start/end/continue/no key video frame data, start/end/continue/no predicted video frame data, and cryptography data (such as key information). Without inspecting the chunk data contents, an intermediate networking device acting as a common carrier of the data could use this information to prioritize stream transmission (such as to assign cryptography and audio data the highest priority, followed by key video frame data and predicted video frame data). In some embodiments, if such information is combined with timestamp information, a storage server may create a time index for an incoming stream, enabling trick play support even for encrypted content with rolling keys, with the time index including cryptography information and key frame time points.

(c) Null data granularity and null data bitmap—Null data granularity and null data bitmap information may enable a common carrier of data to buffer the data stream in an efficient manner. Media streams commonly include null data interspersed among the media data. For example, digital television broadcasts often include null MPEG transport stream packets. In some embodiments, a video storage server could omit these packets and conserve storage space. In this process, null data granularity information indicates the fixed size in which null sections of data are measured within the chunk, while a null data bitmap indicates which sections of the chunk contain null data. In one example, a source that encapsulates MPEG transport stream using the summarization format would set the chunk size to 188 bytes (the size of a transport stream cell), and the null data bitmap field would indicate which of the cells contained null data. A storage device or other network entity with buffering (for example, a bridge device) could then compress and decompress the data chunk without needing to understand the contained format.

(d) Cryptography Cookie—In some embodiments, a cryptography element (or “cookie”) may be provided. The cryptography element may be used to allow an encrypted stream to be transmitted out of order or in a time-shifted manner, and to allow the receiver to appropriately decrypt the modified stream. A media stream may commonly be encrypted with a block cipher, where the block cipher requires a sequence number for each block of data that is to be encrypted or decrypted. In some embodiments, the cryptography element may carry the sequence number, which is typically derived from the sequence number in a network protocol header. When time-shifting or skipping through a media stream, the network protocol sequence numbers would not be usable because these are not preserved through an intermediate device. In some embodiments, the inclusion of a cryptography element in a summary header may enable encrypted data content to be carried through a network without the need for passing keys to entities that will not display the data stream.

(e) Stream-relative timestamp—In some embodiments, a summary header may include a timestamp that reflects timing relative to the data stream. The field may be based upon the presentation time of the first byte of the payload contents. The timestamp may then be used in timing processes for the data stream.

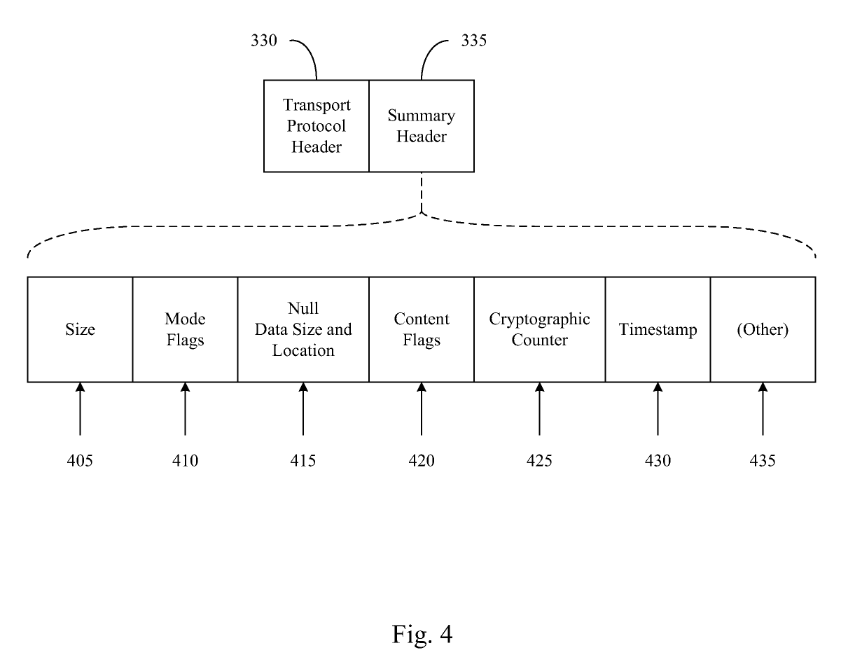

FIG. 4 is an illustration of embodiments of a summary header for data. In this illustration, a data header may include a transport protocol header 330 and a summary header 335, as was shown in FIG. 3. In some embodiments, the summary header may include various fields of data to summarize the data and the relevant processes.

In some embodiments, the fields may include, but are not limited to, a size field for the data chuck 405 (which may be implied by the size of the data packet); mode flags 410 to provide information regarding current operational modes; fields regarding null data size and location in the data chunk 415; content flags 420 to describe the data; a cryptographic element 425 to provide sequence numbering for use of encrypted data; a timestamp 430 that is relative to the stream; and other fields 435. The fields provided may not be provided in all implementations.

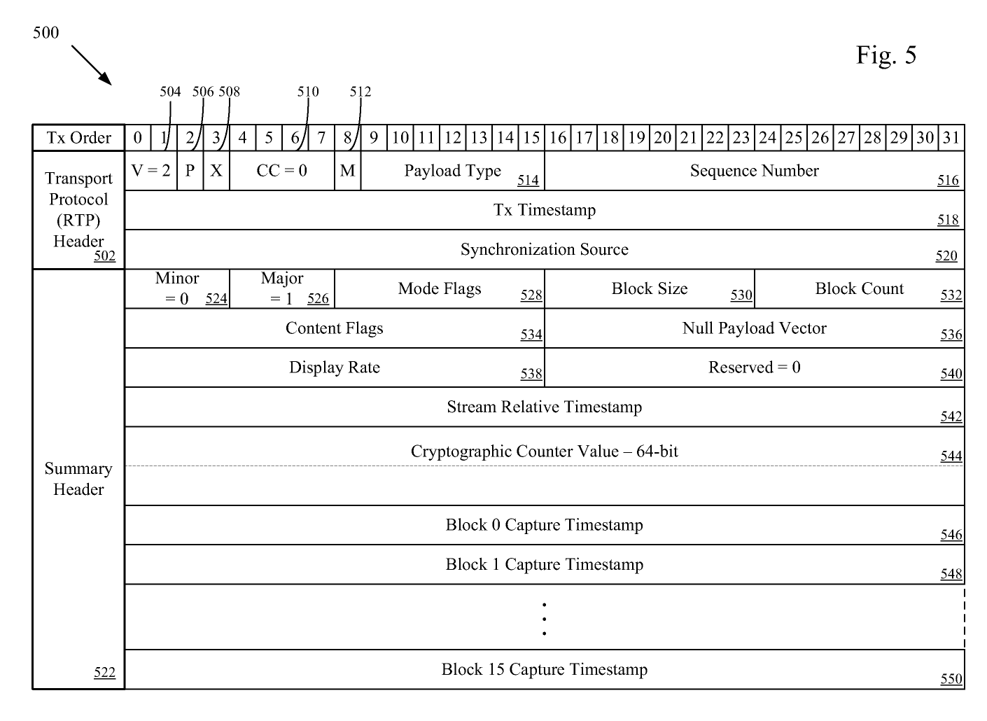

FIG. 5 is an illustration of embodiments of headers provided for data. In some embodiments, network data packets may share a common RTP header format, as depicted in FIG. 5. Any RTP header fields would follow the format and interpretation of the RTP protocol as specified in RFC 3350. In this illustration, all multi-byte fields are represented in network byte order, with specific values for header fields included as appropriate. In some embodiments, when a data stream is delivered in real-time, data packets are encapsulated within UDP/IP protocol packets. The packets are required to be sized to be less than the maximum payload of the underlying link layer (such as Ethernet) so that the packets are not split across multiple UDP/IP packets. When there are no real-time constraints (such as when transferring a piece of content from one device to another), the RTP encapsulation is applied as if the stream were to be delivered using the UDP/IP protocol, but the actual delivery protocol can be TCP/IP. In some embodiments, when the data packets are delivered to the lower network layers for transport, supplemental information may be derived from the header fields to indicate how the packet should be transmitted, such as assigning packet-level priorities based on the payload contents.

While FIG. 5 and the following description of the figure describe certain fields of certain sizes that are located in certain designated positions of a header, embodiments of the invention are not limited to these particular implementations. In some embodiments, the headers include the following fields:

Transport Protocol (RTP) Header 502:

Version (V) 504—The first two bits of the header form the version field. For example, the current RTP version is 2.

Padding (P) Bit 506—The third bit of the RTP header is a padding bit that is reserved for future use, and is zero.

Extension (X) Bit 508—The fourth bit of the RTP header indicates whether an application-specific extension is appended to the common RTP header. In an example, the summary header may be carried as a fixed-size profile extension in the payload of each RTP packet. In this example, the variable-length and variable-position RTP header extension is not used, and thus this bit is zero.

Contributing Source Count (CC) 510—This field (containing four bits) is interpreted as an unsigned integer. It represents the number of contributing sources that, as defined by the RTP protocol, follow the RTP header. If a network does not support the concept of contributing sources, this field is zero.

Marker (M) Bit 512—The ninth bit of the RTP header represents a marker of significant events in the stream data. The interpretation of the marker bit is dependent upon the profile of the content carried in the RTP payload. For example, for audio/video data, this bit is set to one when the timestamp is discontinuous, such as when switching source material or jumping to a different point in the stream. This value is dynamically generated by the transmitter.

Payload Type 514—This 7-bit field is interpreted as an unsigned integer. The payload field indicates the type and format of the payload contents. In RFC 3551, payload type values for the RTP audio/video profile are defined. Some fixed, well-known values are used for common media encoding formats that were extant at the time RTP was developed. In subsequent versions, the RTP specification provides that the range of values from 96 to 127 is reserved for dynamically assigned payload formats. An external mechanism or side channel is expected to be used to negotiate the payload type for a particular RTP session and assign a payload type value from the dynamic range. In some embodiments, the network protocol uses static assignment of payload types from the dynamic range, and thus this specification represents the side channel. For example, the assignment of payload types to the dynamic value range may be as outlined in Table 1.

TABLE 1
Session Manager Event Code Values

| Value | Type | Description |
|---|---|---|
| 96 | MPEG | Any type of MPEG content carried within an MPEG-TS |
| | | format. |
| 97 | AVC/ | Any type of AVC content carried within an MPEG-TS |
| | H.264 | format. |
| 98 | VC-1 | Any type of VC-1 content carried within an MPEG-TS |
| | | format. |
| 99 | JPEG | JPEG content carried within the RTP profile for JPEG |
| | | images. |

In operation, a receiver ignores payload types the receiver does not understand. The payload type value is static and is preserved with the media content.

Sequence Number 516—This 16-bit field in network byte order is interpreted as an unsigned integer. The field represents the sequence number of transmitted RTP packets. The field is incremented by one for each packet sent, regardless of the inherent order of the media itself. Thus, when skipping around within a data stream (such as jumping forward or rewinding), the sequence number is incremented by one for each packet, while the stream data sequence may vary greatly. The initial value of the field is random, and may be dynamically generated by the transmitter.

Transmit Timestamp 518—This 32-bit field in network byte order is interpreted as an unsigned integer. The field represents the instant at which the first byte of the packet is to be transmitted, according to a 90 KHz reference clock at the sender. In another embodiment, a different clock, such as a 27 MHz clock, may be used to provide greater precision. The initial value of the field is random. The receiver may use the transmit timestamp value to determine the nominal packet rate and stream bandwidth and to recover timing via the push model. The value is dynamically generated by the transmitter. In some embodiments, the field could be replaced, but this will provide a non-standard RTP implementation. In some embodiments, a field could be added to the header extension for provide timestamp data.

Synchronization Source 520—This 32-bit field in network byte order represents the source of the media stream. In some embodiments, the network protocol interprets this field as an TPv4 network address representing the IP address of the source of the payload. This value is dynamically generated by the transmitter.

Summary Header 522:

Summary Protocol Version 524, 526—In some embodiments, the summary protocol may evolve over time, and thus a field (shown as 8-bits) may be used to distinguish between different versions of the protocol. In one example, bits 0 through 3 form a version minor number, and bits 4 through 7 form a version major number. For example, the current major number is 1, and the current minor number is 0 (which may be interpreted as version 1.0). The version value may be dynamically generated by the transmitter.

Mode Flags 528—A field (shown in the illustration as 8-bits) represents a bitmap of flags that express information related to the current mode associated with the stream delivery. For example, a value of one in a particular bit position may indicate a positive value for the associated flag, while a value of 0 indicates a negative value. In one possible implementation, the bit assignments for this field may be as outlined in Table 2. The mode flag values are dynamically generated by the transmitter.

TABLE 2
Flag Bit Positions for Stream Mode Settings

| Bit | Flag | Description |
|---|---|---|
| 0 | Encrypted | Indication as to whether the payload contents are |
| | | encrypted. |
| 1 | Reservation | Indication as to whether the transmitter is in a |
| | | bandwidth reservation phase. |
| 2 | Congestion | Indication as to whether the transmitter is experiencing |
| | | congestion. |
| 3 | Trick Play | Indication as to whether trick play mode is in effect. |
| 4 | Splice Mode | Indication as to whether splicing is in use for trick |
| | | play. |
| 5-7 | RFU | Other or Reserved for future use. |

Block Size 530—A block size field (shown here as an 8-bit field) is interpreted as an unsigned integer. The block size field represents the size of blocks of media data in the payload. To facilitate buffer management at the receiver of a media stream, the sections of payload that contain null data, which are sections that need not be stored, are marked. This field indicates the size of such sections. For example, an MPEG transport stream is decomposed into 188-byte cells, some of which may be marked as null cells and merely serve as bandwidth padding. These cells need not be stored. Thus, the null block size field would be set to the size of an MPEG-TS cell, which is 188 bytes. This value is static and is preserved with the media content.

Block Count 532—The block count field (shown here as an 8-bit field) is interpreted as an unsigned integer. It represents the number of blocks of media data in the payload. Each block is of the size indicated by the block size field 530 payload. In an example, it may be required that there be no more than 16 blocks in a packet. Multiplying the block count by the block size and adding the bytes of header (12 bytes of RTP and 88 bytes of summary) yields the total size of the payload In this example, the payload size value is limited to a maximum for UDP, such as 1472 bytes. In some embodiments, the block count value is static and is preserved with the media content.

Content Flags 534—This field (shown as a 16-bit field) represents a bitmap of flags to express information related to payload contents. A value of one in a particular bit position indicates a positive value for the associated flag, while a value of 0 indicates a negative value. The bit assignments for this field may be as outlined in Table 3. This field value is static and is preserved with the media content.

TABLE 3
Flag Bit Positions for Stream Content Attributes

| Bit | Flag | Description |
|---|---|---|
| 0 | Index Start | Payload includes start of index data. |
| 1 | Index Data | Payload includes interior index data. |
| 2 | Index end | Payload includes end of index data. |
| 3 | Audio Data | Payload includes audio data. |
| 4 | Image Data | Payload includes image data. |
| 5 | Primary Video | Payload includes video data from a primary key |
| | | frame, e.g. an MPEG2 I-frame. |
| 6 | Secondary | Payload includes video data from a secondary |
| | Video | key frame, e.g. an MPEG2 P-frame. |
| 7 | Non-key Video | Payload includes video data from a non-key |
| | | frame, e.g. an MPEG2 B-frame. |
| 8 | Splice Data | Payload includes data necessary for splicing |
| | | sections in trick play mode. |
| 9 | Graphics Data | Payload includes embedded graphics data. |
| 10 | Meta Data | Payload includes embedded meta data |
| | | describing the media content. |
| 11 | Crypto Data | Payload includes embedded cryptography |
| | | information, e.g. rolling key information. |
| 12-15 | RFU | Other or Reserved for future use. |

In this example, three index data fields serve as an indication of the index points within the media content. Index data represents a contiguous section of the media content that forms a relatively stable random access point, and thus is media data that can be spliced together while in trick play mode to jump within a stream. In this illustration, there are eight possible values, five of which are unique. A value of zero for all index bits indicates media data that is not suitable for self-contained decode and display, e.g. an MPEG B-frame. The other four unique values indicate the beginning of a section of index data, the interior of a section of index data, the end of a section of index data, and the end of a section of index data followed by the beginning of a new section of index data in the same packet. For example, a packet containing the first byte of an MPEG I-frame would have a value of 1 for the first bit, a value of 0 or 1 (don't care) for the second bit, and a value of 0 for the third bit, indicating the beginning of index data. Subsequent packets that contain the I-frame data would have the first bit set to 0, the second bit set to 1, and the third bit set to 0, indicating interior index data. The packet that contains the last byte of the I-frame would have the first two bits set to 0 and the third bit set to 1, indicating the end of an index section.

Null Payload Vector 536—In this illustration, a null payload vector (shown as a 16-bit field) is interpreted as a vector of flags indicating which sections of the payload contain null data. Each bit represents an indication whether a block of payload (whose size is indicated by the block size field 530) contains null data. Bit 0 refers to the first block of the payload, bit 1 refers to the next block, and so on. When a bit is set to one, it indicates that the corresponding block of the payload contains null data that need not be stored. In this example, the field value is static and is preserved with the media content.

In this illustration, the blocks marked as null are ignored by the receiver and not interpreted. This is because the content may have been encrypted and buffered without storing the null blocks. In this case, the packet would be expanded prior to decryption, which will then yield random data for the null blocks.

Display rate 538—In this illustration, a display rate (illustrated as a 16-bit field) in network byte order represents the stream display rate, which refers to the decode rate as a multiple of normal stream rate, e.g. 1.5 times normal speed. In one example, rates are specified as signed, fixed-point fractional values. Bits 8-15 form the magnitude, while bits 0-7 form the fractional component. A positive value indicates a forward direction, while a negative value indicates a reverse direction. In this example, the field value represents a multiplier that is applied to the normal display rate of one. For example, the hex value 0x0180 represents a magnitude value of 1 and a fractional value of 0.5, which indicates that the desired display rate is 1.5 times normal speed in the forward direction. Any value other than 0x0100 (i.e. normal speed) indicates that the stream is in trick play mode, and the receiver must adjust its decode and display unit accordingly. Changes in trick play mode are indicated by changes in the value of this field. In this example, the display rate is generated dynamically.

Field 540 is illustrated as a reserved field, which may be used in the future for other purposes

Stream-Relative Timestamp 542—This field (shown here as a 32-bit field) is interpreted as an unsigned integer. The field represents the presentation time of the first byte of the payload contents. The value need not be monotonically increasing, as would be the case if bi-directionally predicted video frames are used, such as MPEG B-frames. In one implementation, the timestamp may be assigned based on a stream clock associated with the media contents. This field value is static and is preserved with the media content. The field may be used for mapping a time offset to a byte position in the stream data, which then may enable time-based jumping through the stream.

Cryptographic Counter Value 544—This field (shown as a 64-bit field) represents a counter value that forms a portion of a key index value used to encrypt the media content that is encapsulated within the data stream. The field value is required to be unique across the entire stream, and such value remains constant and associated with the payload contents. In some embodiments, this value is utilized to decrypt the media content for decoding and display. The field value is static and is preserved with the media content.

Block Capture Timestamp List 546-550—In this implementation, when an ingress device captures a media stream and delivers it across a network, the capture timing at the display device is recreated in order to ensure proper timing recovery for correct decoding. This operation is especially important if the stream is stored and played back later or if portions of the stream are dropped at ingress to reduce bandwidth, such as in the case of a high-bandwidth multi-program transport stream being scaled down to a single program transport stream.

In an example, for each stream data block in the payload, the capture timestamp according to a 90 KHz reference clock at the ingress device is added to the summary header. In this example, each timestamp is 32 bits wide and transmitted in network byte order. As illustrated, the header includes 16 slots to hold capture timestamps for the maximum number of allowed blocks in the packet. The list is fixed, regardless of the number of actual blocks in the payload. If the number of blocks in the payload is less than 16, the receiver ignores all unused timestamps. In this implementation, the block capture timestamp values are static and are preserved with the media content.

In some embodiments, a streaming application of a data source may receive low-level feedback from the intended data recipient regarding arriving or lost data packets. In some embodiments, the data source may use the low-level feedback in order to choose an error recovery mechanism. In some embodiments, the use of low-level feedback allows a system to address data delivery issues without complicating the network devices that are present on the entertainment network.

In some embodiments, a summary header includes a sequence number that may be used to provide low level feedback. For example, when the intended data receiver detects an out-of-sequence packet or fails to receive an expected packet within the time frame expected for the given stream, the receive may transmit a negative acknowledgment (NAK) as feedback to the transmitter. The channel for the NAK may be different, and may utilize either a reliable protocol or an unreliable protocol (such as UDP). Upon receiving a NAK, the transmitter may re-send the packet if the packet is still available. In some embodiments, the transmitter may maintain a re-transmit buffer for this purpose. Transmitted packets may be stored in the buffer according to their priority (which may be based upon the packet types according to the summary header flags) and the amount of time for which such a re-transmission would be meaningful. The particular buffer management scheme would be application dependent. In some embodiments, positive acknowledgments (ACK) may also be provided as packets arrive, and thus could be used to evict items from the re-transmit buffer in an efficient manner. However, positive acknowledgements would be provided at the cost of increased feedback.

In some embodiments, the NAKs may be used by a transmitter to detect periods of prolonged data congestion, indicating an overload condition. When an overload condition is thus detected, the transmitter may take appropriate action to address the congestion, such as to switch to a bandwidth-reduced version of the stream, or may stop the stream entirely, which may allow other active streams to continue with high quality. The transmitter may utilize any known congestion detection algorithms, such as, for example, TCP-friendly rate control (TFRC).

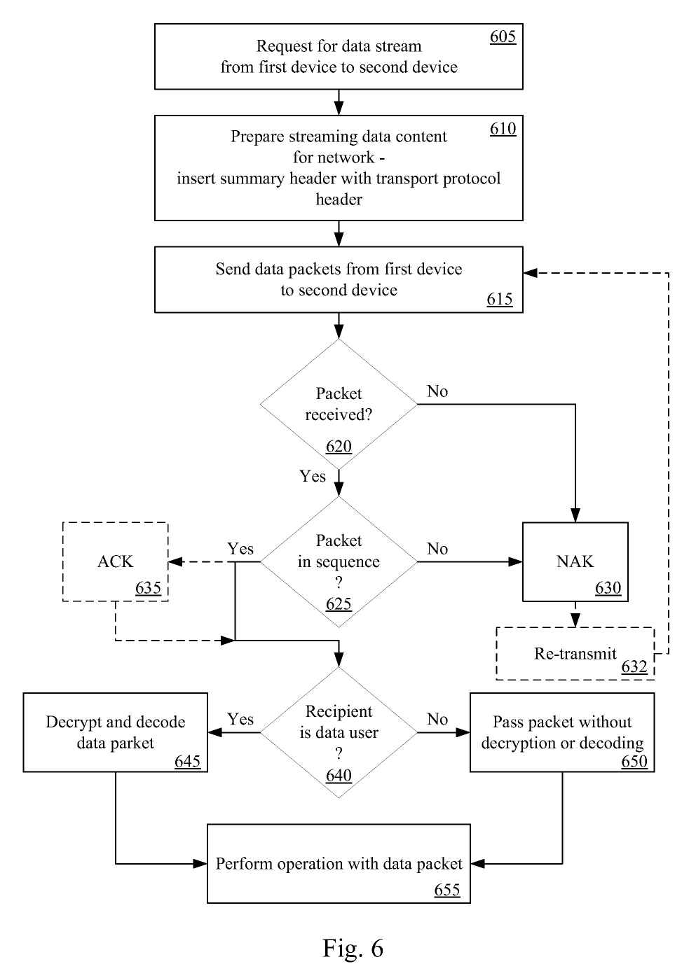

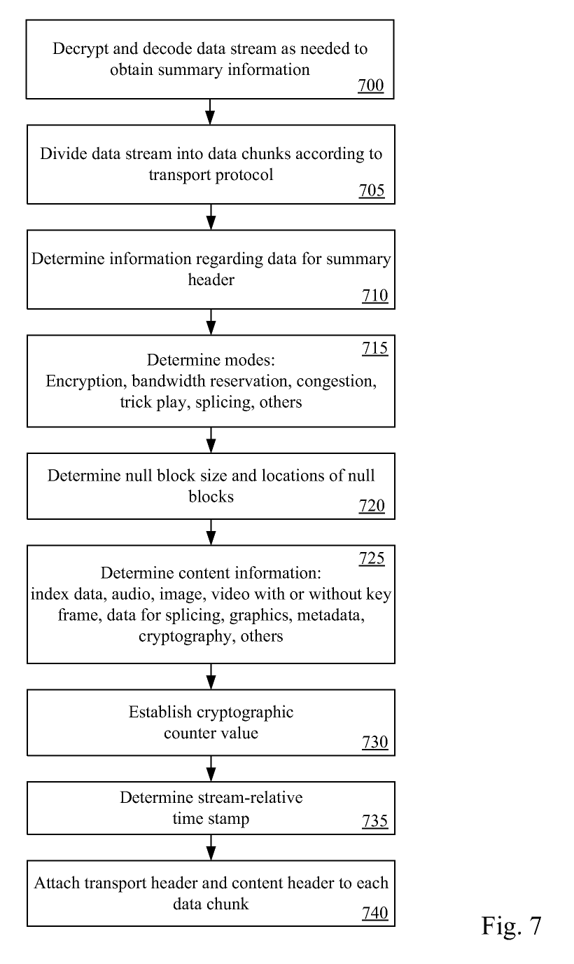

FIG. 6 is an illustration of embodiments of a process for transport of streaming data in a network. In some embodiments, a request is made for the delivery for a data stream from a first device to a second device 605. The request may be made by the first device, or by another device in the network, which may be, for example, a personal entertainment network. The first device prepares the streaming data content for the network 610. The process includes summarizing the content, such as by the insertion of a summary header together with a transport protocol header with each data chunk. The process may include the elements described in FIG. 7. The data packets are then sent from the first device to the second device 615.

In some embodiments, feedback may be provided in connection with the transport of the data. If an expected data packet is not received 620 or is received out of order 625, a negative acknowledgement (NAK) may be sent from the send device to the first device 630. If appropriate for the data content delivery, the first device may then resend the missing packet from a buffer 632. If a packet is received 620 in the proper sequence 625, the second device may optionally send an acknowledgement (ACK) to the first device, which would allow the first device to clear the buffer of the received packet. In addition, the transmission of an acknowledgement may enable the first device to determine that the second device is in fact receiving the data stream, and not dropping all packets in the stream. For a received packet, if the second device is a user of the data (and not an intermediary device) 640, the device may then decrypt and decode the data packet. If the second device is not a user of the data, then the packet is passed without decryption or decoding 650. For either case, the intended operation is then performed with the data packet 655, such as displaying the data or storing the data for future use.

FIG. 7 is an illustration of embodiments of a process for summarization of streaming data. In some embodiments, the data stream may be decrypted and decoded, at least in part, to obtain summary information 700. The data stream is divided into data chunks as required by the transport protocol 705. The information for the summary header is determined for the data chunks. This process may include determining modes of operation, including encryption, bandwidth reservation, congestion, trick play use, splicing, and other modes 715. The process may further include determination of null block sizes and the locations of the null blocks 720. Content information is determined 725, which may include the presence of index data, audio data, image data, video data with or without a key frame, data for splicing, graphics, metadata, cryptography, and other content information. A cryptographic counter value may be included to provide sequence numbering if the data is encrypted 730, and a stream relative time stamp may be established for the data. With the summary information established, the transport protocol header and summary header may be attached to each data chuck 740, and the data may be transported as provided in FIG. 6.

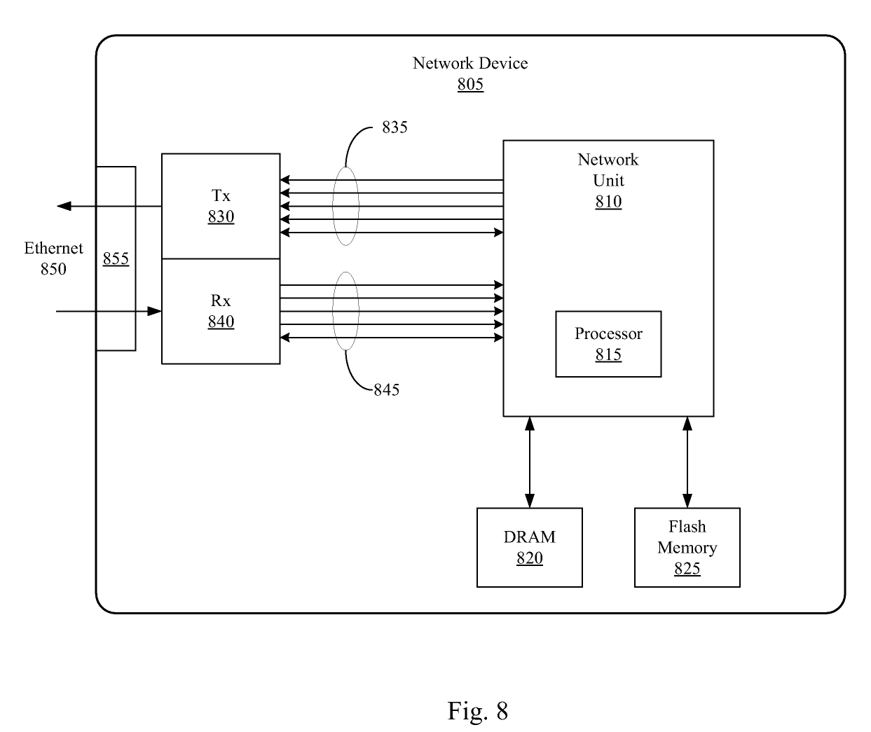

FIG. 8 is an illustration of embodiments of a network device. In this illustration, a network device 805 may be any device in a network such as an entertainment network, including, but not limited to, devices illustrated in FIG. 1. For example, the network device may be a television, a set top box, a storage unit, a game console, or other media device. In some embodiments, the network device 805 includes a network unit 810 configured to provide network functions. The network functions include, but are not limited to, the generation, transfer, storage, and reception of media data streams. The network unit 910 may be implemented as an embedded system. The network unit 810 may be implemented as a single system on a chip (SoC) or as multiple components.

In some embodiments, the network unit 810 includes a processor for the processing of data. The processing of data may include the generation of data streams, the manipulation of data streams for transfer or storage, and the decrypting and decoding of data streams for usage. The network device may also include memory to support network operations, such as DRAM (dynamic random access memory) 820 or other similar memory and flash memory 825 or other nonvolatile memory.

The network device 805 may also include a transmitter 830 and/or a receiver 840 for transmission of data on the network or the reception of data from the network, respectively, via a network interface 855. The transmitter 830 or receiver 840 may be connected to a wired transmission cable, including, for example, an Ethernet cable 850, or to a wireless unit. A wired transmission cable may also include a coaxial cable, a power line, or any other cable or wire that may be used for data transmission. The transmitter 830 or receiver 840 may be coupled with one or more lines, such as lines 835 for data transmission and lines 845 for data reception, to the network unit 810 for data transfer and control signals. Additional connections may also be present. The network device 805 also may include numerous components for media operation of the device, which are not illustrated here.

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form. There may be intermediate structure between illustrated components. The components described or illustrated herein may have additional inputs or outputs which are not illustrated or described. The illustrated elements or components may also be arranged in different arrangements or orders, including the reordering of any fields or the modification of field sizes.

The present invention may include various processes. The processes of the present invention may be performed by hardware components or may be embodied in machine-executable instructions, which may be used to cause a general-purpose or special-purpose processor or logic circuits programmed with the instructions to perform the processes. Alternatively, the processes may be performed by a combination of hardware and software.

Portions of the present invention may be provided as a computer program product, which may include a computer-readable medium having stored thereon computer program instructions, which may be used to program a computer (or other electronic devices) to perform a process according to the present invention. The machine-readable medium may include, but is not limited to, floppy diskettes, optical disks, CD-ROMs (compact disk read-only memory), and magneto-optical disks, ROMs (read-only memory), RAMs (random access memory), EPROMs (erasable programmable read-only memory), EEPROMs (electrically-erasable programmable read-only memory), magnet or optical cards, flash memory, or other type of media/machine-readable medium suitable for storing electronic instructions. Moreover, the present invention may also be downloaded as a computer program product, wherein the program may be transferred from a remote computer to a requesting computer.

Many of the methods are described in their most basic form, but processes can be added to or deleted from any of the methods and information can be added or subtracted from any of the described messages without departing from the basic scope of the present invention. It will be apparent to those skilled in the art that many further modifications and adaptations can be made. The particular embodiments are not provided to limit the invention but to illustrate it. The scope of the present invention is not to be determined by the specific examples provided above but only by the claims below.

If it is said that an element “A” is coupled to or with element “B,” element A may be directly coupled to element B or be indirectly coupled through, for example, element C. When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic is not required to be included. If the specification or claim refers to “a” or “an” element, this does not mean there is only one of the described elements.

An embodiment is an implementation or example of the invention. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. It should be appreciated that in the foregoing description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims are hereby expressly incorporated into this description, with each claim standing on its own as a separate embodiment of this invention.

What is claimed is:

1. An apparatus comprising:
a network unit configured to generate a stream of data, the generation of the stream of data including the generation of summary information for the data and the insertion of the summary information into the stream of data; and
a transmitter configured to transmit the generated stream of data.

2. The apparatus of claim 1, wherein generating the summary information includes decoding the data at least in part and evaluating the decoded data to obtain at least a part of the summary information for the data.

3. The apparatus of claim 1, wherein inserting the summary information into the stream of data includes inserting one or more headers that contain the summary information into the media stream.

4. The apparatus of claim 1, wherein the summary information includes one or more of:
information regarding a mode of operation for the data;
information regarding the content of the data;
an identification of the location of null data in the data;
a cryptographic counter for encrypted data; and
a timestamp value for the data.

5. The apparatus of claim 1, further comprising a receiver to receive a stream of data from a second apparatus.

6. The apparatus of claim 1, wherein the data is media data.

7. An apparatus comprising:
a receiver configured to receive a stream of data from a second apparatus, the data being encoded and containing summary information regarding the data; and
a network unit configured to handle the stream of data based at least in part on the summary information regarding the data.

8. The apparatus of claim 7, wherein the summary information is contained in one or more headers in the stream.

9. The apparatus of claim 7, wherein the handling of the stream of data includes one or more of:
receiving the data and transmitting the data to another apparatus, storing the data, and
utilizing the data.

10. The apparatus of claim 9, wherein the data is transferred or stored without decoding the data.

11. The apparatus of claim 10, wherein the data is encrypted, and wherein the data is transferred or stored without decrypting the data.

12. The apparatus of claim 7, wherein utilizing the data includes decoding the data based at least in part on the summary information.

13. The apparatus of claim 7, wherein the stream of data comprises a stream of media data.

14. A network comprising:
a first network device, the first network device configured to generate a stream of data on the network, the stream of data being encoded according to a data protocol, wherein generating the stream of data includes:
decoding the data at least in part;
evaluating the data to obtain summary information regarding the data, and adding the summary information to the data; and
a second network device, the second network device configured to receive the stream of data from the first network device.

15. The network of claim 14, wherein the second network device handles the received stream of data based on the summary information.

16. The network of claim 14, wherein the second network device is not aware of the content of the data or the coding of the data.

17. The network of claim 14, wherein the data is encrypted, and wherein the second device handles the received stream of data without decrypting the data.

18. The network of claim 14, wherein handling the stream of data includes changing a timing of the stream of data or jumping from a first point to a second point in the stream of media data based on the summary information.

19. The network of claim 14, wherein the second network device provides feedback to the first device regarding the delivery of the stream of data.

20. A method for streaming data comprising:
receiving a request to transfer a data stream from a first device in a network to a second device in the network, the media stream being encoded according to a data protocol, the data stream including a plurality of data chunks;
determining summary information regarding each of the plurality of data packets of the data stream;
attaching the summary information for each data packet of the data stream; and
transmitting the data stream on the network from the first device to the second device.

21. The method of claim 20, wherein the network is an entertainment network.

22. The method of claim 20, further comprising receiving the data stream at the second device.

23. The method of claim 22, further comprising handling the received stream of data by the second device based on the summary information without decoding the data.

24. The method of claim 23, wherein the media data stream is encrypted, and further comprising handling the data stream by the second device without decrypting the data.

25. The method of claim 20, further comprising transferring the received data from the second device to a third device, and further comprising retaining the summary information with each data packet in the transfer to the third device.

26. The method of claim 20, further comprising sending a negative acknowledgement from the second device to the first device if a data packet does not arrive or if the data packet arrives out of order.

27. The method of claim 26, further comprising re-sending a missing data packet from the first device to the second device in response to the negative acknowledgement.

28. The method of claim 20, further comprising sending a positive acknowledgement from the second device to the first device upon receiving a data packet.

29. An article of manufacture comprising:
a computer-readable medium including instructions that, when accessed by a processor, cause the computer to perform operations comprising:
receiving a request to stream data from a first device in a network to a second device in the network using a transfer protocol, wherein the data is encoded according to a data protocol;
decoding the data at least in part;
determining summary information regarding the data;
inserting the summary information into the data; and
transmitting a stream of the data on the network from the first device to the second device.

30. The article of manufacture of claim 29, wherein inserting the summary information into the data includes attaching a data header to a data packet.

31. The article of manufacture of claim 29, wherein the data header is attached after a second data header for the transfer protocol.

32. The article of manufacture of claim 29, wherein the transfer protocol includes Real-time Transfer Protocol (RTP).

33. The article of manufacture of claim 29, wherein the transfer protocol is carried over an unreliable protocol.

34. The article of manufacture of claim 33, wherein the unreliable protocol is UDP (User Datagram Protocol).

35. The article of manufacture of claim 29, wherein the transfer protocol is carried over a reliable protocol.

36. The article of manufacture of claim 35, wherein the reliable protocol is TCP (Transfer Control Protocol).
